(19) United States
(12) Patent Application Publication
(10) Pub. No.: US 2019/0009321 A1
(43) Pub. Date: Jan. 10, 2019

(54) METHOD OF MANUFACTURING PRESS FORMED PRODUCT

(71) Applicant: TOA Industries Co., Ltd., Ota-shi (JP)

(72) Inventors: Yasutaka SUZUKI, Ota-shi (JP); Tadashi IWANUMA, Isesaki-shi (JP); Ken-ichiro MORI, Takarazuka-shi (JP); Yuki NAKAGAWA, Toyohashi-shi (JP)

(73) Assignee: TOA Industries Co., Ltd., Ota-shi (JP)

(21) Appl. No.: 16/014,425

(22) Filed: Jun. 21, 2018

(30) Foreign Application Priority Data
Jul. 4, 2017 (JP) 2017-131344

(51) Int. Cl. B21D 22/20; B21D 35/00; B62D 25/04; B62D 29/00

(52) U.S. Cl. CPC B21D 22/208; B21D 35/007; B21D 22/022; B62D 29/007; B62D 25/04

(57) ABSTRACT

The invention provides manufacturing a press formed product with high corrosion resistance and different tensile strengths depending on regions by a small number of processes. The whole of a steel plate having an aluminum-based plating film is heated to an austenite range temperature by a furnace, so that the body of the steel plate is transformed into austenite and a Fe—Al alloy layer is formed on the surface of the steel plate. The steel plate formed with the Fe—Al alloy layer is taken out from the furnace, a first region of the steel plate is heat-retained by a heat resistant and retaining member, and a second region of the steel plate is cooled naturally. When the temperature of the second region becomes lower than a ferrite transformation start temperature, hot press forming is performed to the steel plate to form a press formed product.

### CROSS-REFERENCE TO RELATED APPLICATIONS

This application claims priority from Japanese Patent Application No. 2017-131344, filed Jul. 4, 2017, the content of which is incorporated herein by reference in its entirety.

### FIELD OF THE INVENTION

The invention relates to a method of manufacturing a press formed product, particularly to a method of manufacturing a press formed product having different tensile strengths depending on regions.

### BACKGROUND OF THE INVENTION

Conventionally, a press formed product having different tensile strengths depending on regions is used in a vehicle structure. For example, a center pillar is made so as to have a large tensile strength at the upper portion and a small tensile strength at the lower portion, thereby controlling the deformation of the center pillar in an event of vehicle impact and preventing the interference of the center pillar with an occupant.

Japanese Patent Application Publication No. 2014-193712 describes a method of manufacturing a press formed product having different tensile strengths depending on regions by welding a steel plate formed by hot press forming (hot stamping) and a steel plate formed by cold press forming, and a method of manufacturing a press formed product having different tensile strengths depending on regions by partially superposing and welding two steel plates having different carbon contents and by performing hot press forming to this.

Japanese Patent Application Publication No. 2016-124029 describes using a steel plate having an aluminum-based plating film so as to prevent scale formation due to high-temperature heating in hot press forming and enhance the corrosion resistance.

By applying a steel plate having an aluminum-based plating film described in Japanese Patent Application Publication No. 2016-124029 to a method of manufacturing a press formed product described in Japanese Patent Application Publication No. 2014-193712, a Fe—Al alloy layer is formed on the surface of a steel plate when heated at high temperature, thereby obtaining a press formed product having high corrosion resistance and different tensile strengths depending on regions.

However, this manufacturing method needs two steel plates and a process of welding these, thereby causing a problem of many processes.

### SUMMARY OF THE INVENTION

To address the problem described above, a method of manufacturing a press formed product of the invention includes: heating a whole steel plate having an aluminum-based plating film to an austenite range temperature so that the body of the steel plate is transformed into austenite and a Fe—Al alloy layer is formed on the surface of the steel plate; heat-retaining a first region of the steel plate formed with the Fe—Al alloy layer by a heat resistant and retaining member and cooling a second region of the steel plate naturally; and forming a press formed product by performing hot press forming to the steel plate when a temperature of the second region of the steel plate becomes lower than a ferrite transformation start temperature (Ar3), wherein a tensile strength of a portion of the press formed product corresponding the first region is larger than a tensile strength of a portion corresponding to the second region.

### BRIEF DESCRIPTION OF THE DRAWINGS

FIG. 1 is a cross-sectional view of a steel plate after heated.

FIG. 2 is a perspective view of a heat resistant and retaining members and the steel plate.

FIG. 3 is a cross-sectional view of the heat resistant and retaining members and the steel plate.

FIG. 4 is a graph showing the temperature changes of the steel plate.

FIGS. 5A and 5B are cross-sectional views showing hot press forming.

FIG. 6 is a perspective view of a press formed product.

### DETAILED DESCRIPTION OF THE INVENTION

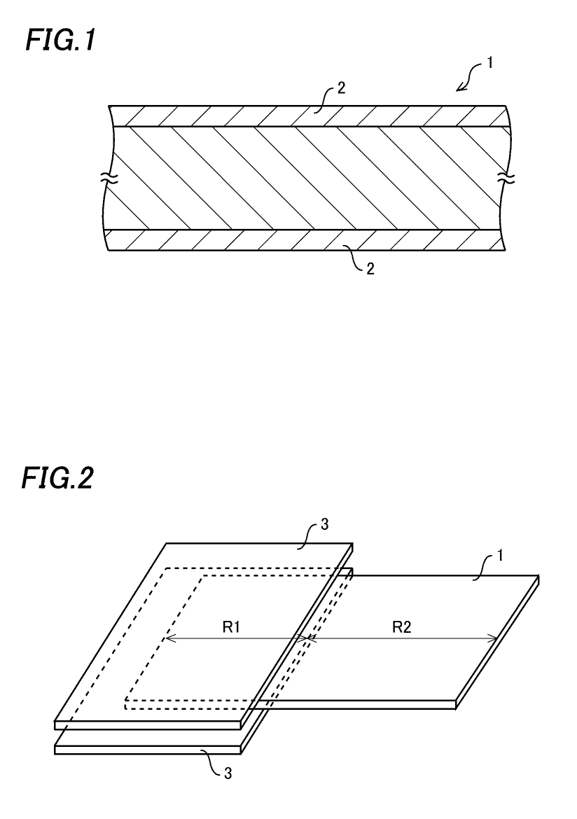

An embodiment of the invention will be described referring to figures. First, a whole steel plate 1 having an aluminum-based plating film on the whole front and back surface is heated by a furnace to an austenite range temperature T0, thereby transforming the body of the steel plate 1 into austenite and alloying Al in the aluminum-based plating film and Fe in the steel plate 1 to form a Fe—Al alloy layer 2 having high corrosion resistance on the whole front and back surface of the steel plate 1 as shown in FIG. 1.

The austenite range temperature T0 is, for example, about 900° C., although it differs depending on the carbon content of the steel plate 1. The aluminum-based plating film is an aluminum plating film containing 10% Si, for example.

In the described heating process, it is preferable to obtain the Fe—Al alloy layer 2 having a five-layered structure by controlling the heating amount of the steel plate 1 properly in order to obtain high weldability thereafter. From a Fe—Al—Si phase diagram, etc., in general, this five-layered structure is supposed to contain Fe₂Al₅ in the first and third layers from the front surface, a mixed layer of Fe₂Al₅, FeAl, and Fe₃Si₂Al₃ in the second layer, FeAl in the fourth layer, and Al ferrite solid solution in the fifth layer. The five-layered structure is described, for example, in an article, the Journal of the Japan Welding Society, pp. 23˜30, no. 6, vol. 78 (2009).

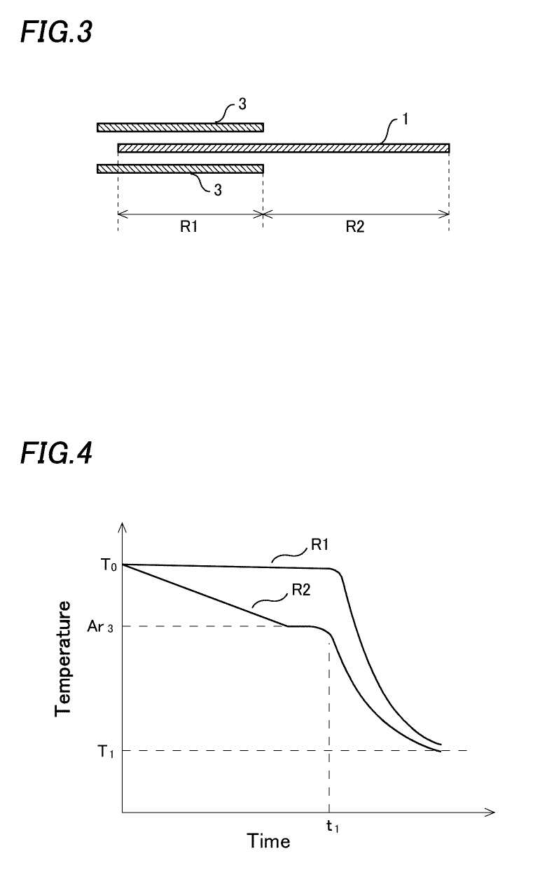

The steel plate 1 is divided in a longitudinal direction into a first region R1 and a second region R2 of the rest as shown in FIG. 2 and FIG. 3, and the steel plate 1 formed with the Fe—Al alloy layer 2 is taken out from the furnace. Heat resistant and retaining members 3 are disposed over the first region R1 of the steel plate 1 so as to retain the heat, and the second region R2 of the steel plate 1 is exposed from the heat resistant and retaining members 3 so as to be naturally cooled by air at ordinary temperature. The heat resistant and retaining member 3 is preferably a glass wool member with high heat resistance and high heat retainability.

While the heat resistant and retaining members 3 are disposed over the front and back surface of the first region R1 of the steel plate 1 in the embodiment, the heat retainability is enhanced by forming a sac-like heat resistant and retaining member 3 and covering the whole first region R1 of the steel plate 1 including the end face.

Then, as shown in FIG. 4, the temperature of the first region R1 is retained at the austenite range temperature T0 (for example, 900° C. to 950° C.) by heat retaining effect, while the temperature of the second region R2 is gradually decreased from the austenite range temperature T0 without heat retaining effect. When the temperature of the second region R2 becomes lower than the ferrite transformation start temperature (Ar3) (at time t1 in FIG. 4), hot press forming is performed to the steel plate 1, thereby forming a press formed product.

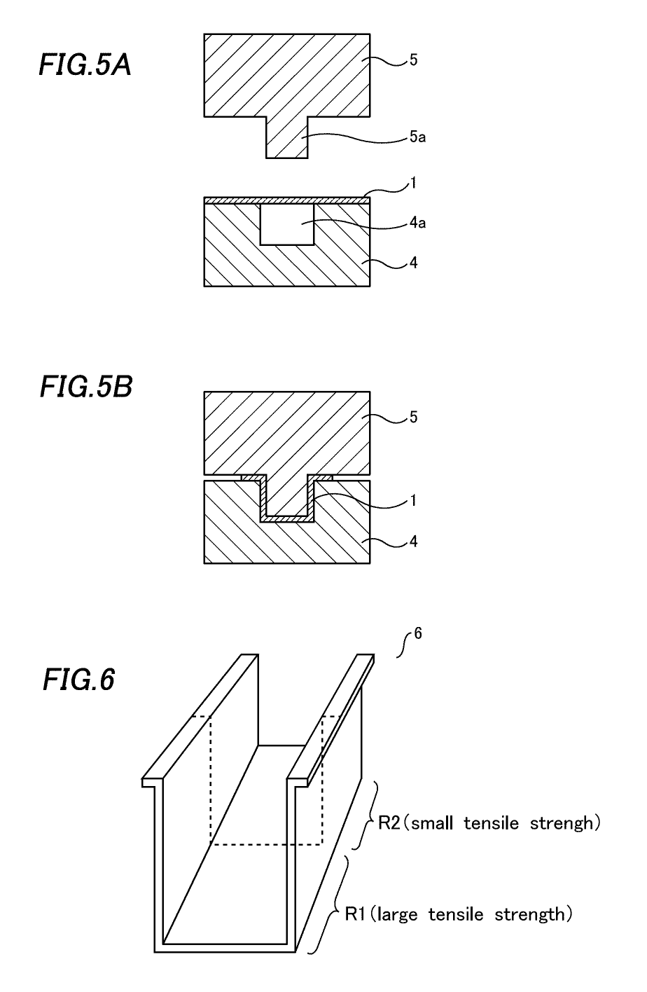

FIG. 5A and FIG. 5B are cross-sectional views showing an embodiment of this hot press forming. As shown in the figures, a hot press forming machine is provided, which has an upper die 5 having a convex portion 5a disposed above a lower die 4 having a concave portion 4a, the convex portion 5a being to be engaged with the concave portion 4a. As shown in FIG. 5A, the steel plate 1 is set on the lower die 4, and the upper die 5 is moved downward by a drive device to press the steel plate 1 between the lower die 4 and the upper die 5, thereby performing the rapid cooling and press forming of the steel plate 1 simultaneously as shown in FIG. 5B.

At this time, the first and second regions R1, R2 of the steel plate 1 are rapidly cooled to the temperature T1 (for example, 200° C.) as shown in FIG. 4. Since the first region R1 is rapidly cooled from the high temperature T0 in the austenite range, martensite transformation occurs and quenching is achieved. On the other hand, the second region R2 is rapidly cooled from the temperature lower than the ferrite transformation start temperature (Ar3), and thus martensite transformation does not occur and it is not quenched.

The dies are then opened, and a press formed product 6 shown in FIG. 6 is taken out. This hot press forming achieves such control that the tensile strength of the portion corresponding to the first region R1 of the press formed product 6 is, for example, 1500 MPa, and the tensile strength of the portion corresponding to the second region R2 is, for example, about 590 MPa.

Furthermore, since the steel plate 1 having an aluminum-based plating film is used as a member, the Fe—Al alloy layer 2 is formed when it is heated at high temperature, and thus scale formation is prevented, thereby enhancing the corrosion resistance.

As described above, in the embodiment, the whole steel plate 1 is uniformly heated at high temperature, the heat resistant and retaining members 3 are then used to provide a temperature difference between the first region R1 and the second region R2 of the steel plate 1, and the temperature difference is used to selectively quench and reinforce the first region R1 only. On the other hand, it is conceivable that only the first region R1 may be heated to the austenite range temperature in the high temperature heating for obtaining a temperature difference from the second region R2. However, this method may cause insufficiency in the heating of the second region R2 and the formation of the Fe—Al alloy layer 2, thereby degrading the corrosion resistance.

Although the steel plate 1 is divided in the longitudinal direction into the first region R1 and the second region R2 of the rest in the embodiment, the steel plate 1 may be divided into arbitrary regions. For example, a middle region of the steel plate 1 may be determined as a first region R1, and a region on either side of the first region R1 may be determined as a second region R2. This case is the same in a point that the heat resistant and retaining members 3 are disposed over the first region R1 of the steel plate 1 to retain the heat, and the second region R2 of the steel plate 1 is exposed from the heat resistant and retaining member 3 to be naturally cooled by air at ordinary temperature. Furthermore, the steel plate 1 may be divided into three or more regions, and a region which need to have high tensile strength may be heat-retained by the heat resistant and retaining members 3.

What is claimed is:

1. A method of manufacturing a press formed product, comprising:
heating a whole steel plate having an aluminum-based plating film to an austenite range temperature so that a body of the steel plate is transformed into austenite and a Fe—Al alloy layer is formed on the surface of the steel plate;
heat-retaining a first region of the steel plate on which the Fe—Al alloy layer is formed by a heat resistant and retaining member and cooling a second region of the steel plate naturally; and
forming a press formed product by performing hot press forming to the steel plate when a temperature of the second region of the steel plate becomes lower than a ferrite transformation start temperature,
wherein a tensile strength of a portion of the press formed product corresponding to the first region is larger than a tensile strength of a portion corresponding to the second region.

2. The method of claim 1, wherein the heat resistant and retaining member comprises a glass wool member.
